(19) United States
(12) Patent Application Publication
(10) Pub. No.: US 2019/0064327 A1
(43) Pub. Date: Feb. 28, 2019

(54) OBJECT DETECTION APPARATUS

(71) Applicants: Hoshibumi Ichiyanagi, Aichi (JP); Hidenori Miyazaki, Aichi (JP)

(72) Inventors: Hoshibumi Ichiyanagi, Aichi (JP); Hidenori Miyazaki, Aichi (JP)

(73) Assignee: OMRON AUTOMOTIVE ELECTRONICS CO., LTD., Aichi (JP)

(21) Appl. No.: 16/110,523

(22) Filed: Aug. 23, 2018

(30) Foreign Application Priority Data
Aug. 28, 2017 (JP) 2017-162990

(51) Int. Cl. G01S 7/481; G01S 17/02

(52) U.S. Cl. CPC G01S 7/4817; G01S 7/4815; G01S 17/026

(57) ABSTRACT

During a first scanning duration in which projection light is reflected by a first reflection surface of a mirror of the rotary scanning unit, light emitting elements are caused to sequentially emit light, a light receiving element corresponding to a light emitting element in a light-emitted state is caused to sequentially receive the reflection light, and a light reception signal output from the light receiving element in the light-received state is sequentially selected by a signal selection unit. During a second scanning duration in which the projection light is reflected by a second reflection surface of the mirror, a specific light emitting element of the light emitting elements is caused to emit light with a prescribed period, the light receiving elements are caused to sequentially receive the reflection light, and the light reception signal output from the light receiving element in the light-received state is sequentially selected.

### CROSS-REFERENCES TO RELATED APPLICATIONS

This application is based upon and claims the benefit of priority from Japanese Patent Application No. 2017-162990, filed on Aug. 28, 2017; the entire contents of which are incorporated herein by reference.

### FIELD

One or more embodiments of the present invention relate to an object detection apparatus that projects light from a light emitting element, causes a light receiving element to receive a reflection signal that results from the projected light being reflected, and detects an object based on a reception signal that is output from the light receiving element.

### BACKGROUND

For example, an object detection apparatus, such as a laser radar, is mounted in a vehicle or the like that has a collision prevention function. The object detection apparatus projects light from a light emitting element, causes a light receiving element to receive a reflection signal that results from the projected light being reflected, and determines whether an object is present or absent and measures a distance to the object, based on a reception signal that is output from the light receiving element.

As the light emitting element, a laser diode or the like is used. As the light receiving element, a photodiode, an avalanche photodiode, the like is used. Furthermore, in order to project and receive light over a wide range, there are also a plurality of light emitting elements or a plurality of light receiving elements are also used. Furthermore, instead of the light receiving element, there is also a complementary metal oxide semiconductor (CMOS) image sensor or the like is also used.

Moreover, in order to project and receive light over a wide range, miniaturize an apparatus, and so forth, there is also an object detection apparatus that has a function of scanning or distributing light in the horizontal direction or in the vertical direction (for example, JP-A-2014-52366, JP-A-2014-219250, and JP-A-2012-237604).

A rotary scanning unit that has a mirror with six plane faces is included in an object detection apparatus in JP-A-2014-52366. A central axis vertical with respect to an upper-and-lower surface of the mirror is a rotation shaft. Four side surfaces of the mirror are reflection surfaces, and are inclined at different angles with respect to the rotation shaft. The mirror is caused to rotate about the rotation shaft, and thus the projection light that is projected from the light emitting element (a laser light source) is reflected from each reflection surface and is scanned over a prescribed range. Furthermore, the reflection light that is reflected from an object in the prescribed range is reflected from each reflection surface of the mirror, and is led to the light receiving element (a light detector). At the time of projecting and receiving light, the projection light or the reflection light is scanned not only in the horizontal direction, but also in the vertical direction.

A first scanning mirror and a second scanning mirror are included in an object detection apparatus in JP-A-2014-219250. These scanning mirrors are formed in the shape of a plate, and the plate-shaped surface is a reflection surface. An angle of the first scanning mirror is changed by a controller, and thus light that is projected from the light emitting element is reflected from the first scanning mirror and is scanned over a prescribed range. Furthermore, an angle of the second scanning mirror is changed by the controller, and thus the reflection light that is reflected from an object in the prescribed range is reflected from the second scanning mirror and is led to the light receiving element.

A half mirror and two diffractive optical elements are included in an object detection apparatus in JP-A-2012-237604. The half mirror separates light that is projected from the light emitting element, and the lights that result from the separation are incident on the diffractive optical elements, respectively. Each diffractive optical element converts the incident light from the half mirror into dot pattern lights, and the dot patterns light irradiate different prescribed areas.

Without the same angular resolution being obtained, the precision of detection of the object varies between a case where an object is located at a remote distance from the object detection apparatus and a case where the object is located at a short distance from the object detection apparatus. In the case where the object is located at a remote distance and the case where the object is located at a short distance, states where light from the object detection apparatus irradiates the object are different (JP-A-2012-237604), states where the reflection light that results from the object is incident on the object detection apparatus are different, states where the reflection light forms an image due to a lens or the like within the object detection apparatus are different, (JP-A-2014-52366) and so forth. These are causes of the difference in the precision of the detection of the object. For this reason, when the precision of the detection of the object that is located at a remote distance is increased, the precision of the detection of the object that is located at a short distance is decreased.

Accordingly, in order that the precision of the detection of the object that is located at a short distance is increased as well, in JP-A-2014-52366, an optical path from the light emitting element to a conjugate image of the light emitting element due to a light projection lens is set to be at infinity, and an optical path from the light emitting element to the conjugate image of the light receiving element due to a light receiving lens is set to be at a closer position than the optical path that is set to be at infinity. Furthermore, in JP-A-2012-237604, light that is projected from the light emitting element is converted by a plurality of diffractive optical elements into dot pattern lights, and the dot pattern lights irradiate a prescribed area in a wide range of angles.

Furthermore, in the background art in JP-A-2014-219250, it is disclosed that many light receiving elements are provided in an array, that the light receiving element that is associated with a scanning position of the projection light from the light emitting element is selected by a multiplexer, and that an object is detected based on the light reception signal which is output from the light emitting element. Accordingly, the number of noise component that are included in the light reception signal is reduced, but a circuit is made on a massive scale. Accordingly, in JP-A-2014-219250, in order to increase the precision of the detection of the object that is located at a short distance without causing a circuit to be scaled up, an angle of the second scanning mirror is controlled based on a distance to the object that is previously detected and on an angle information on the first scanning mirror at the time of the light projection.

### SUMMARY

In a case where the object is located at a remote distance, because a geometrical deviation between an optical path for the projection light and an optical path for the reflection light is small, or the light receiving element that corresponds to the scanning position of the projection light from the object detection apparatus or to the light emitting element which emits the projection light is selected by the multiplexer. Thus, based on the light reception signal that is output from the light receiving element, it can be precisely determined whether the object is present or absent and the distance to the object can be precisely measured. However, in a case where the object is located at a short distance, because the geometrical deviation between the optical path for the projection light and the optical path for the reflection light is large, in some cases, there occurs a difference in angle between the optical path for the projection light and the optical path for the reflection light, and the reflection light is not incident on the light receiving element that corresponds to the scanning position of the projection light or to the light emitting element which emits the projection light. For this reason, although the light receiving element that corresponds to the scanning position of the projection light or to the light emitting element that emits the projection light is selected by the multiplexer, there is a concern that, based on the light reception signal that is output from the light receiving element, it will not be precisely determined whether the object is present or absent and the distance to the object will not be precisely measured.

An object of one or more embodiments of the present invention is to provide an object detection apparatus that is capable of precisely detecting both an object that is located at a remote distance and an object that is located at a short distance.

According to an aspect of the present invention, there is provided an object detection apparatus including: a plurality of light emitting elements; a rotary scanning unit that includes a mirror and, by causing the mirror to rotate, reflects projection light projected from the light emitting elements by from the mirror and scans the reflected projection light over a prescribed range; a plurality of light receiving elements each of which receives reflection light of the projection light and reflected from an object in the prescribed range and which outputs a light reception signal in accordance with a light-received state; a signal selection unit that selects any of light reception signals output from the plurality of light receiving elements; and an object detection unit that detects the object based on the light reception signal which is selected by the signal selection unit. The mirror includes first reflection surface and a second reflection surface that do not belong in the same plane. Then, during a first scanning duration in which the projection light is reflected by the rotary scanning unit from the first reflection surface and is scanned over the prescribed range, the plurality of light emitting elements are caused to sequentially emit light, the light receiving element that corresponds to a light emitting element in a light-emitted state of the plurality of light receiving elements, is caused to sequentially receive the reflection light, and the signal selection unit is caused to sequentially select the light reception signal that is output from the light receiving element in the light-received state.

Furthermore, during a second scanning duration in which the projection light is reflected by the rotary scanning unit from the second reflection surface and is scanned over a prescribed range, a specific light emitting element of the plurality of light emitting elements is caused to emit light with a prescribed period, the plurality of light receiving element are caused to sequentially receive the reflection light, and the signal selection unit is caused to sequentially select the light reception signal that is output from the light receiving element in the light-received state.

When implementation is realized as described above, during the first scanning period, the light from each of the plurality of light emitting elements is projected sequentially, and the projection light is reflected from the first reflection surface of the mirror of the rotary scanning unit and is scanned over the prescribed range. At this time, in a case where the object is located at a remote distance, when the projection light from any of the light emitting elements is reflected from the object, the reflection light is incident on the light receiving element that corresponds to the light emitting element. For this reason, the signal selection unit is caused to select the light reception signal that is output from the light receiving element which corresponds to the light emitting element in the light-emitted state, and thus the object can be detected precisely by the object detection unit based on the light reception signal.

Furthermore, during the second scanning duration, the light is projected with a prescribed period from a specific light emitting element, and the projection light is reflected from the second reflection surface of the mirror of the rotary scanning unit and is scanned over a prescribed range. At this time, if the object is located at a short distance, in some cases, the reflection light that results from the projection light being reflected from the object is incident on the light receiving element that does not correspond to a specific light emitting element. However, a plurality of light receiving elements are caused to sequentially receive the reflection light and the signal selection unit is caused to sequentially select the light reception signal that is output from the light receiving element in the light-received state. Because of this, the reflection light is received in any of the light receiving elements and the signal selection unit is caused to select the light reception signal that is output from the light receiving element. More precisely, switching among a plurality of light receiving elements and between the light reception signals that are output from the plurality of light receiving elements are performed and thus the reflection light that results from the projection light from a specific light emitting element being reflected from the object is searched for. For this reason, any of the light receiving elements is caused to receive the reflection light, the signal selection unit is caused to select the light reception signal that is output from the light receiving element, and thus, based on the light reception signal, the object can be detected precisely by the object detection unit.

According to the aspect of the present invention, a width of the second reflection surface in parallel with a scanning plane for the projection light resulting from the rotary scanning unit, may be narrower than a width of the first reflection surface in parallel with the scanning plane.

Furthermore, according to the aspect of the present invention, the mirror may be formed in a plate shape, the first reflection surface may be provided on a plate-shaped surface of the mirror, and the second reflection surface may be provided on a side surface of the mirror which has an area smaller than that of the plate-shaped surface.

Furthermore, according to the aspect of the present invention, the plurality of light emitting elements may be arranged so as to be aligned in a direction perpendicular to the scanning plane for the projection light resulting from the rotary scanning unit, and during the first scanning duration, the light receiving element corresponding to the light emitting element in the light-emitted state and also corresponding to a reflection direction of the projection light resulting from the first reflection surface, may be caused to sequentially receive the reflection light.

Furthermore, according to the aspect of the present invention, during the first scanning duration, the object detection unit may measure a distance to the object based on the light-emitted state of the light emitting element and based on the light reception signal that is selected by the signal selection unit, and during the second scanning duration, the object detection unit may determine whether the object is present or absent, based on the light-emitted state of the light emitting element and based on the light reception signal that is selected by the signal selection unit.

Moreover, according to the aspect of the present invention, the object detection apparatus may further include an analog-to-digital converter that converts the light reception signal in analog form, which is selected by the signal selection unit, into a light reception signal in digital form, and outputs the light reception signal to the object detection unit, and the analog-to-digital converter may be caused to intermittently operate so as to correspond to switching of selection of the reception light signals by the signal selection unit.

According to one or more embodiments of the present invention, it is possible that an object detection apparatus that is capable of precisely detecting both an object that is located at a remote distance and an object that is located at a short distance is provided.

### BRIEF DESCRIPTION OF DRAWINGS

FIG. 1A is a diagram illustrating a state of an optical system of an object detection apparatus according to an embodiment of the present invention, which viewed from above;

FIG. 1B is a diagram illustrating a state where an angle in FIG. 1A changes;

FIG. 2 is a diagram illustrating a state of the optical system of the object detection apparatus in FIG. 1A, when viewed from the rear;

FIG. 3 is a front-view diagram of a LD group in FIG. 1A;

FIG. 4 is a front-view diagram of a PD group in FIG. 1A;

FIG. 5 is a diagram illustrating an electrical configuration of the object detection apparatus in FIG. 1A;

FIG. 6 is a diagram illustrating states where the object detection apparatus projects and receives light in FIG. 1A;

FIG. 7 is a diagram illustrating states where the object detection apparatus projects and receives light to and from an object that is located at a remote distance in FIG. 1A;

FIG. 8 is a diagram illustrating stated where the object detection apparatus projects and receives light to and from an object that is located at a short distance in FIG. 1A;

FIG. 9 is a diagram illustrating a light projection and reception timing of the object detection apparatus in FIG. 1A during a first scanning duration; and

FIG. 10 is a diagram illustrating a light projection and reception timing of the object detection apparatus in FIG. 1A during a second scanning duration.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Embodiments of the present invention will be described below with reference to the drawings. The same or corresponding constituent components in figures are the same reference numbers.

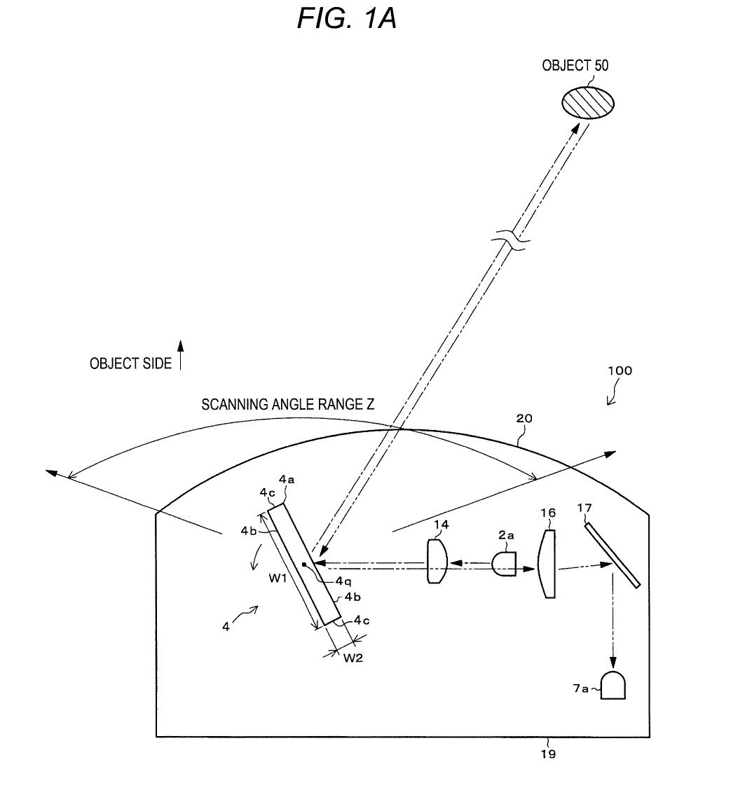

First, a structure and operation of an optical system of an object detection apparatus 100 according to the present embodiment will be described with reference to FIGS. 1A to 4.

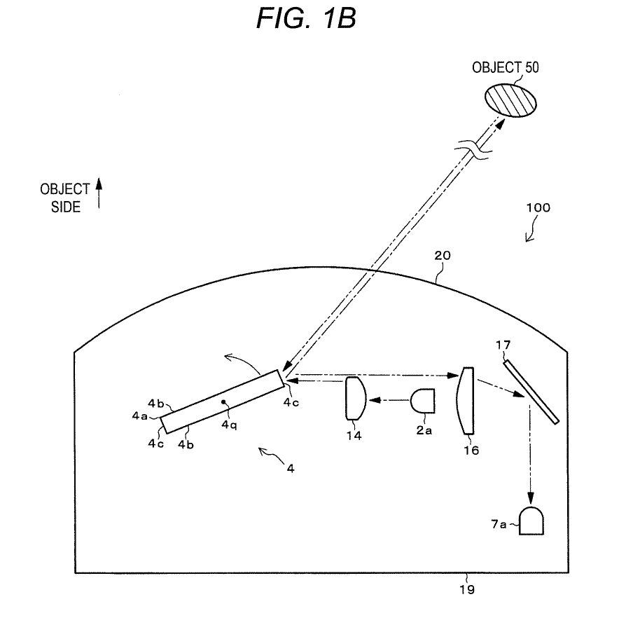

FIGS. 1A and 1B are diagrams, each illustrating an optical system of the object detection apparatus 100 when viewed from above. In FIGS. 1A and 1B, angles of a mirror 4a are different from each other. FIG. 2 is a diagram illustrating a state of the optical system of the object detection apparatus 100, when viewed from the rear (the downward direction in FIGS. 1A and 1B, that is, the direction opposite to an object 50). In FIGS. 1A and 2, the angles of the mirror 4a are the same.

The object detection apparatus 100, for example, is made up of a laser radar that is mounted in a four-wheeled vehicle. The optical system of the object detection apparatus 100 is made up of a laser diode (LD) group 2a, a light projection lens 14, a rotary scanning unit 4, a light receiving lens 16, a reflecting mirror 17, and an avalanche photodiode (PD) 7a.

The LD group 2a, the light projection lens 14, and the rotary scanning unit 4 among these are a light-projecting optical system. Furthermore, the rotary scanning unit 4, the light receiving lens 16, the reflecting mirror 17, and the PD group 7a are a light-receiving optical system.

These optical systems are accommodated within a case 19 of the object detection apparatus 100. A front surface of the case 19 (the object 50 side) is open. The light transmitting window 20 is provided on the front surface of the case 19. The light transmitting window 20 is made up of a window frame that is rectangle-shaped, and a plate that has transmissibility, which is fitted into the window frame (detailed illustrations of these are omitted).

The light transmitting window 20 is installed in such a manner as to face in the forward direction, the backward direction, or the leftward and rightward directions from a vehicle, and the object detection apparatus 100 is installed in the front portion, the rear portion, or the left-side and light-side portions of the vehicle. The object 50 is a preceding vehicle, a person, or any other object, that is present outside of the object detection apparatus 100.

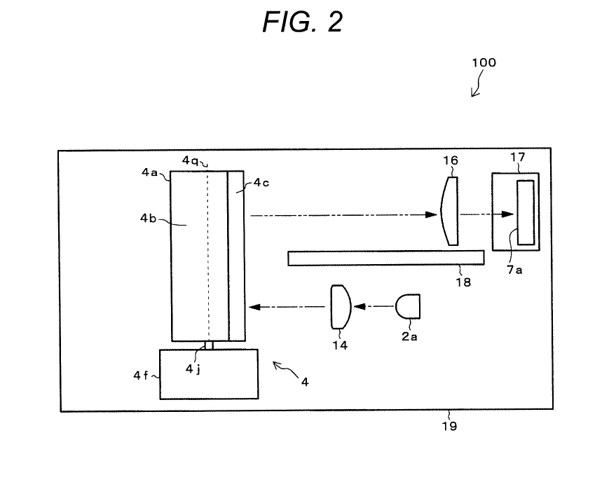

FIG. 3 is a front-view diagram (a diagram when the light emission surface side is viewed) of the LD group 2a. The LD group 2a is configured from a plurality of laser diodes, an LD₁ to an LD₈. In FIG. 3, light emission surfaces of the LD₁ to the LD₈. The LD₁ to the LD₈ are light emitting elements each of which projects high-output laser light. The LD₁ to the LD₈ are arranged in the upward-downward direction (a direction that is the same as the upward-downward direction in FIG. 2) in such a manner that the light emission surfaces thereof face the rotary scanning unit 4 side. The LD₁ to the LD₈ are hereinafter collectively expressed as the LD.

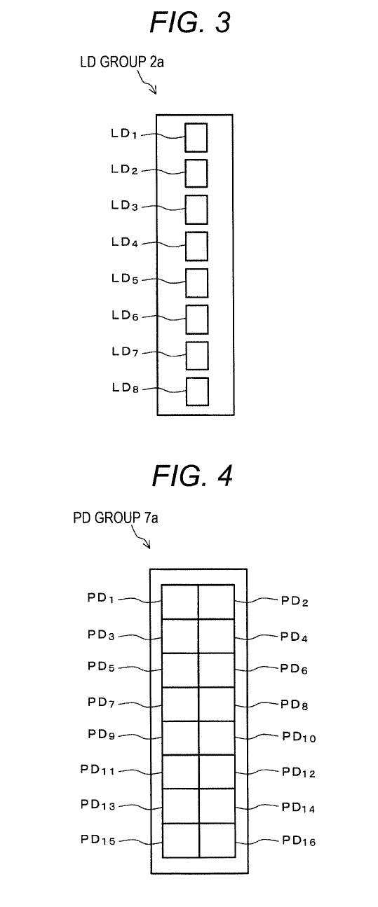

FIG. 4 is a front-view diagram (a diagram when the light reception surface side is viewed) of the PD group 7a.

The PD group 7a is configured from a plurality of PIN type photodiodes, a PD₁ to a PD₁₆. In FIG. 4, light emission surfaces of the PD₁ to PD₁₆ are illustrated. The PD₁ to the PD₁₆ are light receiving elements that receive the laser light (projection light) which is projected from the LD₁ to the LD₈, or reflection light or the like which results from the laser light being reflected from the object 50. The PD₁ to the PD₁₆ are arranged in the upward-downward direction (a direction that is the same as the upward-downward direction in FIG. 2) and the leftward-rightward direction (a direction that is the same as the leftward-rightward direction in FIGS. 1A to 2) in such a manner that the light reception surfaces thereof face the reflecting mirror 17 side. The PD₁ to the PD₁₆ are hereinafter collectively as the PD.

The rotary scanning unit 4 that is illustrated in FIGS. 1A to 2 is also referred to as a rotating mirror or an optical deflector. The rotary scanning unit 4 includes a mirror 4a, a motor 4f, and the like. The mirror 4a is formed in the shape of a rectangular plate. A first reflection surface 4b that reflects light is provided on both entire plate-shaped surfaces (front and rear surfaces) of the mirror 4a. A second reflection surface 4c that reflects light is provided on entire both side surfaces in the longitudinal direction of the mirror 4a. The first reflection surface 4b and the second reflection surface 4c do not belong to the same plane. Furthermore, an area of the second reflection surface 4c is narrower than an area of the first reflection surface 4b.

As illustrated in FIG. 2, the motor 4f is provided under the mirror 4a. The mirror 4a is fixed to an upper end of the rotation shaft 4j in such a manner that a rotation shaft 4j of the motor 4f is in a straight line with a central axis 4q of the mirror 4a. The rotation shaft 4j and the central axis 4q are in parallel in the upward-downward direction, and the first reflection surface 4b and the second reflection surface 4c are in parallel. The mirror 4a interlocks with the rotation shaft 4j of the motor 4f and rotates about the central axis 4q.

Within the case 19, the light receiving lens 16, the reflecting mirror 17, and the PD group 7a are arranged in the vicinity of an upper portion of the mirror 4a of the rotary scanning unit 4. The LD group 2a and the light projection lens 14 are arranged in the vicinity of a lower portion of the mirror 4a. A light shielding plate 18 is provided over the LD group 2a and the light projection lens 14 and under the light receiving lens 16. The light shielding plate 18 is fixed within the case 19, and separates a light projection path and a light receiving path. The light transmitting window 20 is provided over the rotary scanning unit 4 in such a manner to be positioned in a light scanning range, and divides the object detection apparatus 100 into two partitions, the inside and the outside.

The light projection and light reception paths for detecting the object 50 are as indicated by dashed line and two-dot chain line arrows, respectively, in FIGS. 1A and 2. Specifically, as illustrated by the dashed line arrow in FIGS. 1A and 2, spread of the laser light that is projected from each LD in the LD group 2a is adjusted by the light projection lens 14, and then reaches a half portion of any of the reflection surfaces 4b and 4c of the mirror 4a of the rotary scanning unit 4.

On this occasion, the motor 4f rotates, and thus an angle (a slope) of the mirror 4a changes. As a result, for example, as illustrated in FIG. 1A, any of the reflection surfaces, the first reflection surface 4b, makes a prescribed angle with respect to the LD group 2a to face the object 50 side. When this is done, as illustrated by the dashed line arrow in FIGS. 1A and 2, the laser light is reflected from the first reflection surface 4b, passes through the light transmitting window 20, and is projected over a prescribed range outside of the case 19.

Furthermore, when, as illustrated in FIG. 1B, any of the reflection surfaces, the second reflection surface 4c, makes a prescribed angle with the LD group 2a to face the object 50 side, as illustrated by the dashed line arrow, the laser light is reflected from the second reflection surface 4c, passes through the light transmitting window 20, and is projected over the prescribed range outside of the case 19.

Moreover, any of the reflection surfaces 4b and 4c rotates in a range of angles that any of the reflection surfaces 4b and 4c makes with respect to the LD group 2a to face the object 50 side, and thus the laser light is reflected from the reflection surfaces 4b and 4c and is scanned over the prescribed range in the horizontal direction. As described above, a plurality of LDs are provided in the upward-downward direction in FIG. 2, that is, in the direction vertical to a scanning plane (a horizontal plane) for the laser light, which results from the rotary scanning unit 4. For this reason, the laser light is projected sequentially from each LD and the mirror 4a is caused to rotate, and thus, the laser light is also scanned in the upward-downward direction (a perpendicular direction).

A duration in which, with the rotary scanning unit 4, the laser light from the LD is reflected from the first reflection surface 4b and is scanned over a prescribed range is hereinafter referred to as a first scanning duration. Furthermore, a duration in which, with the rotary scanning unit 4, the laser light from the LD is reflected from the second reflection surface 4c and is scanned over a prescribed range is hereinafter referred to as a second scanning duration.

As illustrated in FIG. 1A and other figures, a width W2 of the second reflection surface 4c in parallel with the scanning plane for the laser light from the LD, which results from the rotary scanning unit 4 is narrower than a width W1 of the first reflection surface 4b in parallel with the scanning plane. For this reason, the second scanning duration in which the second reflection surface 4c is used is shorter than the first scanning duration in which the first reflection surface 4b is used.

A scanning angle range Z that is illustrated in FIG. 1A is a prescribed range (when viewed from above) in the horizontal direction where the laser light from the LD is reflected from the first reflection surface 4b of the mirror 4a and is projected from the object detection apparatus 100. That is, the scanning angle range Z is a range where the object 50 is detected with the first reflection surface 4b of the object detection apparatus 100.

It is noted that, although not illustrated, the range where the object 50 is detected with the second reflection surface 4c, that is, a prescribed range in the horizontal direction where the laser light from the LD is reflected from the second reflection surface 4c and is projected from the object detection apparatus 100 is smaller than the scanning angle range Z. This is because the width W2 of the second reflection surface 4c is narrower than the width W1 of the first reflection surface 4b and the second reflection surface 4c rotates along a trajectory closer to the LD group 2a or the light projection lens 14 than the first reflection surface 4b. However, for example, a distance from the second reflection surface 4c to the LD group 2a or the light projection lens 14, or a shape or performance of the light projection lens 14 is adjusted, and thus the range where the object 50 is detected with the second reflection surface 4c can be set to be almost the same as the range where the object 50 is detected with the first reflection surface 4b.

As described above, the laser light that is projected over the prescribed arrange from the object detection apparatus 100 is reflected from the object 50 that is present in the prescribed range. The reflection light, as indicated by the two-dot chain line arrow FIGS. 1A to 2, passes through the light transmitting window 20, and reaches a half portion of any of the reflection surfaces 4b and 4c of the mirror 4a.

On this occasion, the motor 4f rotates, and thus the angle (the slope) of the mirror 4a changes. As a result, for example, as illustrated in FIG. 1A, any of the reflection surfaces, the first reflection surface 4b, makes a prescribed angle with respect to the light receiving lens 16 to face the object 50 side. When this is done, as illustrated by the two-dot chain line arrow in FIGS. 1A and 2, the reflection light from the object 50 is reflected from the first reflection surface 4b and is incident on the light receiving lens 16.

Furthermore, as illustrated in FIG. 1B, when any of the reflection surfaces, the second reflection surface 4c makes a prescribed angle with respect to the light receiving lens 16 to face the object 50, as indicated by the two-dot chain line arrow, the reflection light from the object 50 is reflected from the second reflection surface 4c and is incident on the light receiving lens 16.

Moreover, any of the reflection surfaces 4b and 4c rotates in a range of angles that any of the reflection surfaces 4b and 4c makes with respect to the light receiving lens 16 to face the object 50 side, and thus the reflection light from the object that is present in the prescribed range is reflected from any of the reflection surfaces 4b and 4c and is incident on the light receiving lens 16. Then, the reflection light that is incident on the light receiving lens 16, as indicated by the two-dot chain line arrow in FIGS. 1A to 2, is focused by the light receiving lens 16, and then is reflected from the reflecting mirror 17 and is received in the PD in the PD group 7a. More precisely, the rotary scanning unit 4 scans the reflection light from the object 50 that is present in the prescribed range and guides the reflection light to the PD via the light receiving lens 16 and the reflecting mirror 17.

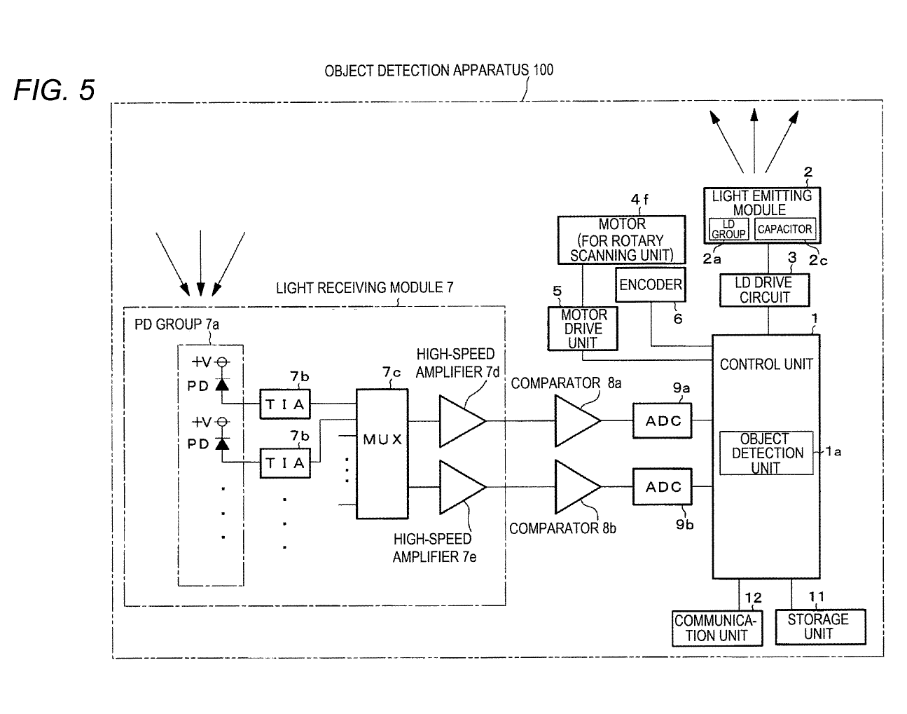

Next, an electrical configuration of the object detection apparatus 100 will be described with reference to FIG. 5.

FIG. 5 is a diagram of an electrical configuration of the object detection apparatus 100. The object detection apparatus 100 includes a control unit 1, a light emitting module 2, a LD drive circuit 3, the motor 4f, a motor drive circuit 5, an encoder 6, a light receiving module 7, comparators 8a and 8b, an analog-to-digital converters (ADCs) 9a and 9b, a storage unit 11, and a communication unit 12.

The control unit 1 is made up of a microcomputer or the like, and controls operation of each of the units of the object detection apparatus 100. An object detection unit 1a is provided in the control unit 1.

The storage unit 11 is made up of a volatile or nonvolatile memory. Stored in the storage unit 11 are information that is necessary for the control unit 1 to control each of the units of the object detection apparatus 100, information for detecting the object 50, or the like.

The communication unit 12 is made up of a communication circuit for communicating with an electronic control unit (ECU) that is mounted in the vehicle. The control unit 1 transmits and receives various pieces of information to the ECU using the communication unit 12.

The LD group 2a, a capacitor 2c for causing each LD in the LD group 2a, and the like are provided in the light emitting module 2. In FIG. 5, for convenience, the LD is not illustrated, and one capacitor 2c block is illustrated.

The control unit 1 controls operation of each LD in the LD group 2a using the LD drive circuit 3. Specifically, the control unit 1 causes each LD to be emitted using the LD drive circuit 3 and projects the laser light. Furthermore, the control unit 1 causes each LD to stop emitting light, using LD drive circuit 3, and charges the capacitor 2c that releases electric charge and thus is discharged.

The motor 4f is a drive source that causes the mirror 4a of the rotary scanning unit 4 to be driven. The control unit 1 controls the driving of the motor 4f using the motor drive circuit 5 and causes the mirror 4a to rotate. Then, the control unit 1, as described above, causes the mirror 4a to rotate, and thus, causes the laser light, which is projected from the LD, to be reflected from any of the reflection surfaces 4b and 4c and to be scanned over the prescribed range, causes the reflection light, which is reflected from the object 50 that is present in the prescribed range, to be reflected from any of the reflection surfaces 4b and 4c, and leads the reflection light to the PD group 7a. On this occasion, based on an output of the encoder 6, the control unit 1 detects a rotation state (a rotation angle or the number of rotations) of the motor 4f or the mirror 4a.

Included in the light receiving module 7 are the PD group 7a, a trans-impedance amplifier (TIA) 7b, a multiplexer (MUX) 7c, and high-speed amplifiers 7d and 7e. A plurality of TIAs 7b are provided in such a manner that the plurality of TIAs 7b and the PDs in the PD group 7a are grouped into sets of one TIA and one PD. Typically, two sets of the PD and the TIA 7b are illustrated in FIG. 5, but three or more sets of the PD and the TIA 7b are also provided in the same manner. There are a total of 16 sets of the PD and the TIA 7b, and each set constitutes a light reception channel. More precisely, a plurality of light reception channel (a total of 16 channels) are provided in the light receiving module 7.

A cathode of each PD is connected to a power source +V. An anode of each PD is connected to an input terminal of each TIA 7b. An output terminal of each TIA 7b is connected to the MUX 7c. Each PD receives light and thus outputs current (a light reception signal). Each TIA 7b converts current flowing through the PD that is connected, into a voltage signal and outputs the voltage signal to the MUX 7c.

The MUX 7c selects the voltage signal that is output from a plurality of TIAs 7b and outputs the selected voltage signal to any of the high-speed amplifiers 7d and 7e. The high-speed amplifiers 7d and 7e switch between gains at a high speed, amplifies an output signal of the MUX 7c, and outputs the amplified output signal to the comparators 8a and 8b. Accordingly, the voltage signal in accordance with a light-received state of each PD is output sequentially from the light receiving module 7 to the comparators 8a and 8b. The MUX 7c is an example of a “signal selection unit” according to the embodiment of the present invention.

There are provided two sets, one set of the high-speed amplifiers 7d, the comparators 8a, and the ADC 9a and the other set of the high-speed amplifiers 7e, the comparators 8b, and the ADC 9b. This is in order to perform signal processing on the light reception signal that is output from the light receiving module 7 in two systems and thus achieve a speed-up of the processing.

The comparator 8a compares an output signal of the high-speed amplifier 7d with a prescribed threshold and thus distinguishes whether the output signal is the reflection signal that is based on the reflection signal which results from the output signal being reflected from the object 50, or noise. The comparator 8b compares an output signal of the high-speed amplifier 7e with a prescribed threshold and thus distinguishes whether the output signal is the reflection signal that is based on the reflection signal which results from the output signal being reflected from the object 50, or noise. Specifically, in a case where the output signals of the corresponding high-speed amplifiers 7d and 7e are at or above the thresholds, respectively, the comparators 8a and 8b, this indicates that the output signals are the reflection light signals. Because of this, the comparators 8a and 8b output prescribed signals (for example, high-level signals) to the corresponding ADCs 9a and 9b, respectively. Furthermore, in a case where the output signals of the corresponding high-speed amplifiers 7d and 7e are at or below the thresholds, respectively, this indicates that the output signals are noise. Because of this, the comparators 8a and 8b do not output the prescribed signals to the ADC 9a and 9b, respectively.

As another example, in a case where the output signals of the high-speed amplifiers 7d and 7e are at or below the thresholds, respectively, the comparators 8a and 8b may output prescribed signal (for example, low-level signals) to the ADCs 9a and 9b, and may not output signals at all.

The ADCs 9a and 9b convert analog signals that are output from the corresponding comparators 8a and 8b, respectively, into analog signals (prescribed signals) at a high speed, and outputs the analog signals to the control unit 1. Specifically, when prescribed signals are output from the comparators 8a and 8b, respectively, the ADCs 9a and 9b convert the prescribed signals into digital “1” signals, and outputs the “1” signals to the control unit 1. Furthermore, when the prescribed signals are not output from the comparators 8a and 8b, respectively, the ADCs 9a and 9b output digital “0” signals, to the control unit 1. The ADCs 9a and 9b are examples of an analog-to-digital converter according to the embodiment of the present invention.

As described above, the light reception signal (the voltage signal) in accordance with the light-received state of each PD is output from the light receiving module 7 to the control unit 1 via the comparators 8a and 8b and the ADCs 9a and 9b.

During the first duration and the second duration, which are described above, based on an output signal of any of the ADCs 9a and 9b, the object detection unit 1a of the control unit 1 determines whether the object 50 is present or absent or measures a distance to the object 50. Specifically, for example, based on the “1” signal and/or the “0” signal that is output from the ADCs 9a and 9b, the object detection unit 1a determines whether or the object 50 is present or absent.

Furthermore, for example, the object detection unit 1a detects measures the light projection time for the laser light from the LD, and, based on the 1″ signal and/or the “0” signal that is output from the ADCs 9a and 9b, measures the light reception time for the reflection light that results from the laser light being reflected from the object 50. Then, based on the light projection time for the laser light and the light reception time for the reflection light, the distance to the object 50 is calculated. For details, a time of flight (TOF) for the laser light that is projected from the LD is measured, and, based on the TOF, the distance to the object 50 is calculated.

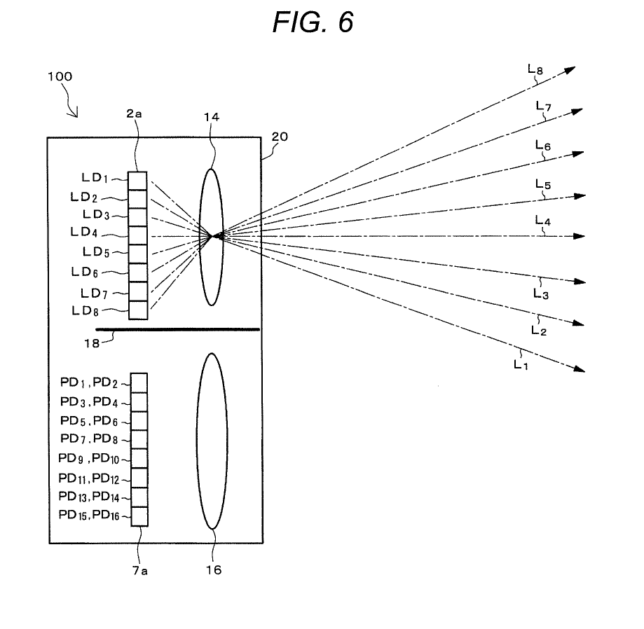

Next, states where the object detection apparatus 100 projects and receives light to and from the object 50 will be described with reference to FIGS. 6 to 8.

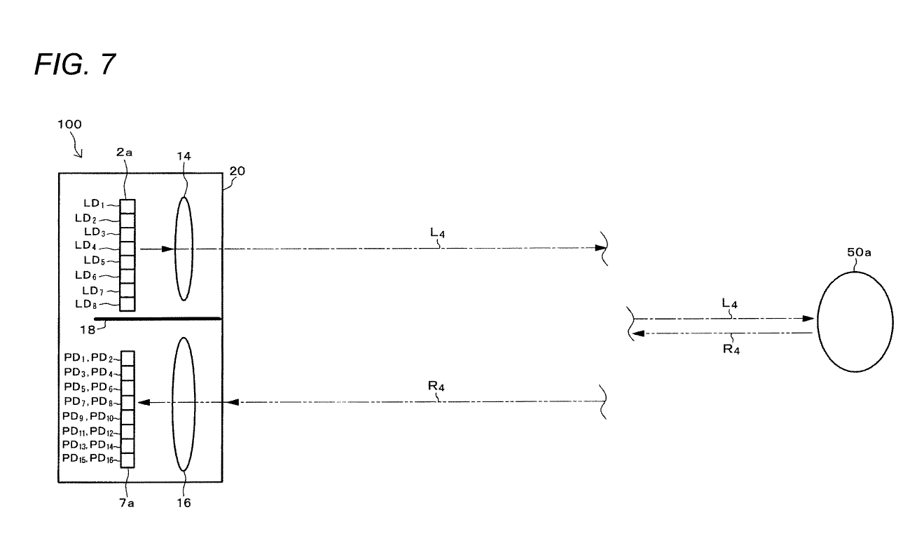

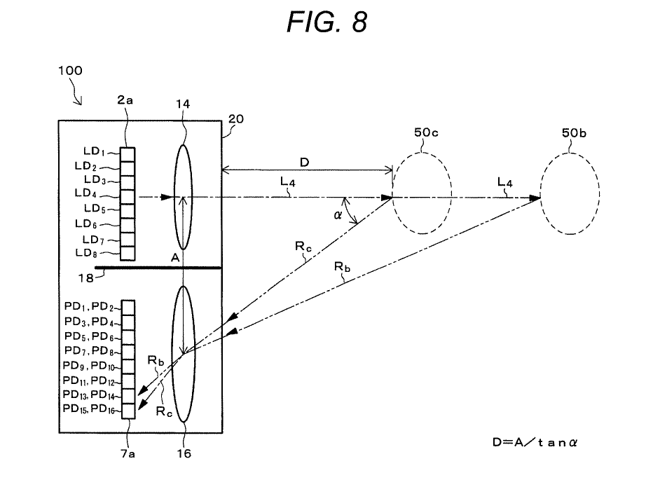

FIG. 6 is a diagram illustrating states where the object detection apparatus 100 projects and receives light. FIG. 7 is a diagram illustrating states where the object detection apparatus 100 projects and receives light to and from the object 50 that is located at a remote distance. FIG. 8 is a diagram illustrating states where the object detection apparatus 100 projects and receives light to and from the object 50 that is located at a short distance. In FIGS. 6 to 8, for convenience, the LD group 2a, the PD group 7a, the light projection lens 14, and the light receiving lens 16 within the object detection apparatus 100 are schematically illustrated. Furthermore, the upward-downward direction in FIGS. 6 to 8 is the same as the upward-downward direction in FIGS. 2 to 5, and is a perpendicular direction.

As described above, the LD₁ to the LD₈ are arranged in the upward-downward direction in the LD group 2a. Furthermore, the PD₁ to the PD₁₆ are arranged in pairs in the upward-downward direction in the PD group 7a.

The LD₁ to the LD₈, as illustrated in by a dashed line arrow in FIGS. 6 to 8, project laser light L₁ to laser light L₈ toward a prescribed point of the compass in the perpendicular direction via the rotary scanning unit 4 or the like. Specifically, as illustrated in FIG. 6, the LD₁ that is present at the uppermost position projects the laser light L₁ at projection angle (an angle with respect to the horizontal direction) in the lowermost direction. The LD₈ that is present at the lowermost position project the light L₈ at a projection angle (an angle with respect to the horizontal direction) in the uppermost direction. The LD₄ in the middle projects the laser light L₄ horizontally. According to arrangement positions, the LD₂ and the LD₃ projects the laser light L₂ and the laser light L₃, respectively, in the downward direction, at different projection angles that are smaller than a projection angle of the LD₁ and are greater than a projection angle of the LD₄. The LD₅ to LD₇ project the laser light L₅ to the laser light L₇, in the upward direction, at different angles that are smaller than a projection angle of the LD₈ and are greater than a projection angle of the LD₄.

Incidentally, when considering a case where the laser light that is projected from any of the LDs via the rotary scanning unit 4, for example, is reflected from an object that is located at a distance of 100 m, the LD and the PD are extremely in proximity to each other when compared with a distance to the object. Because of this, there is no problem in regarding the LD and the PD as being located at approximately the same position. Therefore, an optical path for the projection light that is projected from the LD to the object and an optical path for the reflection light can be regarded as being approximately in parallel. Then, the reflection light is received in a PD that corresponds to the LD that projects the laser light.

Specifically, for example, as illustrated in FIG. 7, reflection light R₄ that results from the laser light L₄ projected in the horizontal direction from the LD₄ being reflected from an object 50a that is located at a remote distance is incident on the light transmitting window 20 approximately in parallel with the laser light L₄, that is, at an angle of approximately 0° with respect to the horizontal direction, and is received in the PD₇ and the PD₈ that correspond to the LD₄. The reflection light that results from the laser light from the LD₁ being reflected is incident on the light transmitting window 20 approximately in parallel with the laser light, and is received in the PD₁ and PD₂ that correspond to the LD₁, with an illustration of this being omitted. The reflection light that results from the laser light from the LD₂ being reflected is incident on the light transmitting window 20 approximately in parallel with the laser light and is received in the PD₃ and the PD₄ that correspond to the LD₂. In the same manner, the reflection light that results from the laser light from each of the LD₃, LD₅, LD₆, LD₇, and LD₈ is incident on the light transmitting window 20 approximately in parallel with the laser light, and is received in the PD that corresponds to the LD.

On the other hand, when considering a case where the laser light that is projected from any of the LDs via the rotary scanning unit 4, for example, is reflected from the object that is located at a short distance of less than 10 m, because the distance to the object is short, regarding the projection light and the reflection light being approximately in parallel is problematic. For this reason, in some cases, the reflection light that results from the reflection from the object is incident on the light transmitting window 20 at an angle that is not in parallel with the projected laser light. In this case, the reflection light is not received in the PD that corresponds to the LD that projects the laser light.

Specifically, for example, as illustrated in FIG. 8, reflection light R_{b} and reflection light R_{c} that result from the laser light L₄ projected in the horizontal direction from the LD₄ being reflected from objects 50b and 50c, respectively, that are located at a short distance are incident on the light transmitting window 20 that is at a prescribed angle with respect to the laser light L₄, instead of being incident on the light transmitting window 20 that is in parallel to the laser light L₄. For this reason, the reflection light R_{b} and the reflection light R_{c} are received in the PD₁₃ to the PD₁₆ that do not correspond to the LD₄, instead of being received in the PD₇ and PD₈ that correspond to the LD₄. Furthermore, the shorter is distances to the objects 50b and 50c, the greater is angles that laser light L₄ and the reflection light R_{b} and the reflection light R_{c}. For this reason, the reflection light R_{b} that results from the reflection from the object 50b is received in the PD₁₃ and the PD₁₄, and the reflection light R_{c} that results from the reflection from the object 50c that is located a shorter distance than the object 50b is received in the PD₁₅ and the PD₁₆. In the same manner, the reflection light that results from the laser light projected from each of the other LDs being reflected from the objects 50b and 50c is also received in the PD that does not correspond to the LD, instead of being received in the PD that corresponds to the LD, with an illustration of this being omitted.

The distance to the object 50a (FIG. 7) that is located at a remote distance, as described above, can also be measured using a TOF method. The distances to the objects 50b and 50c (FIG. 8) that are located at a short distance, as described above, can also be measured using the TOF method, but can be measured using a position of the PD in which the reflection light that results from the reflection from each of the objects 50b and 50c is received after being focused by the light receiving lens 16.

For example, as illustrated in FIG. 8, in a case where the laser light L₄ is projected in the horizontal direction, an arrival angle of α of the reflection light R_{c} is measured from positions of the PD₁₅ and the PD₁₆ that receive the reflection light R_{c}. Then, with the arrival angle of α and an inter-center distance A between the light projection lens 14 and the light receiving lens 16, a distance D up to the object 50c is calculated using the following arithmetic-operation expression.

D=A/tan α

This calculation of the distance D is performed by the object detection unit 1a.

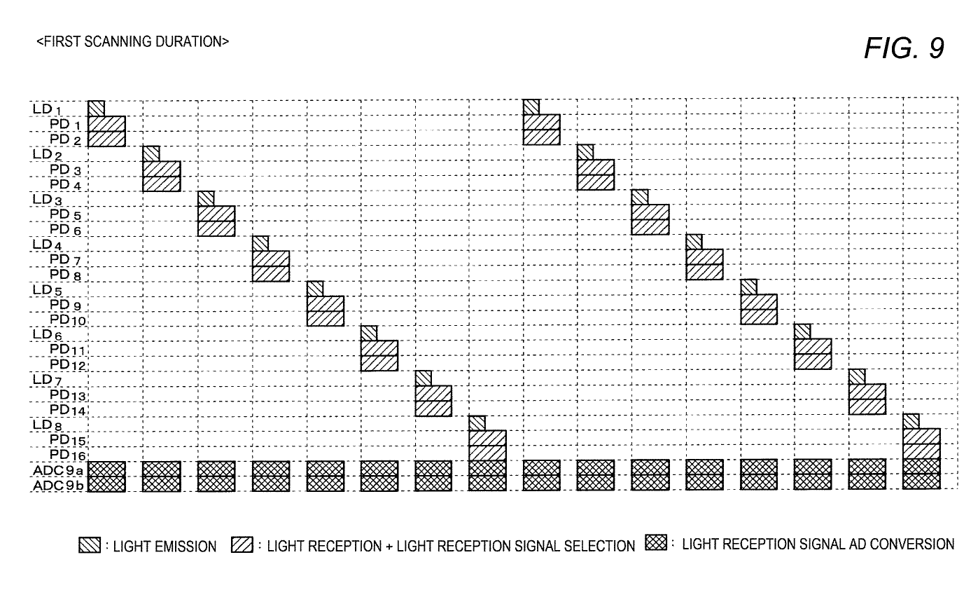

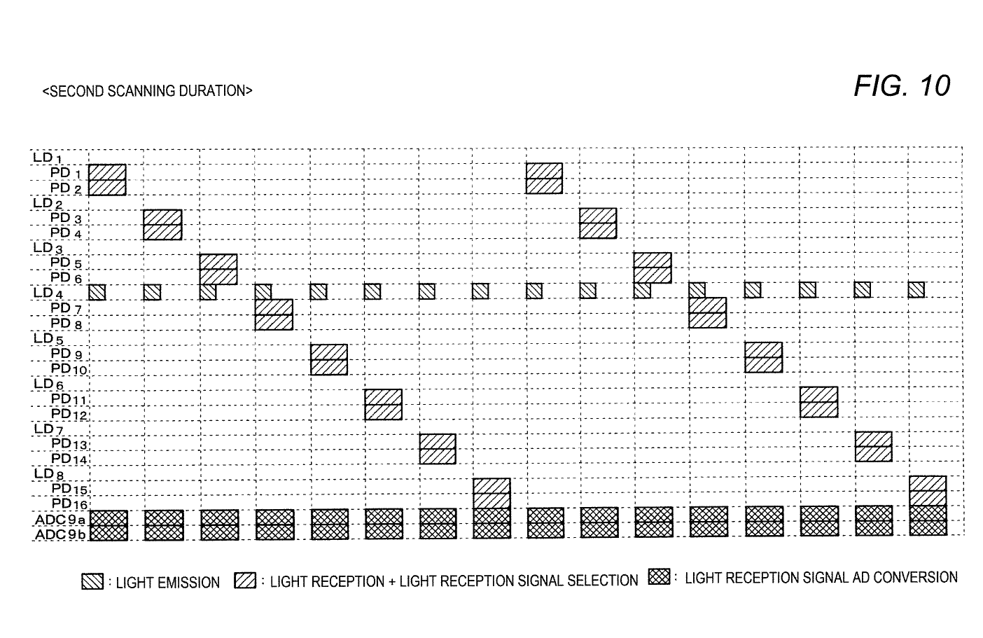

Next, a light projection and reception timing for the object detection apparatus 100 will be described with reference to FIGS. 9 and 10.

FIG. 9 is a diagram illustrating the light projection and reception timing of the object detection apparatus 100 during the first scanning duration. FIG. 10 is a diagram illustrating the light projection and reception timing of the object detection apparatus 100 during the second scanning duration.

In FIGS. 9 and 10, the horizontal direction indicates time, and the vertical direction indicates the LD₁ to the LD₈, the PD₁ to the PD₁₆, and the ADCs 9a and 9b. A bar including lines that are inclined rightward from right to left indicates a duration in which the LD₁ to LD₈ performs a light emitting operation. A bar including lines that are included upward from right to left indicates a duration in which the PD₁ to PD₁₆ perform a light receiving operation and the light reception signals from the PD₁ to PD₁₆ are selected in the MUX 7c. A bar including rightward-inclined lines and leftward-inclined lines that intersect indicates a duration in which the ADCs 9a and 9b are driven and thus an analog-to-digital conversion of the light reception signal is performed.

The first scanning duration in which, with the rotary scanning unit 4, the laser light from the LD group 2a is reflected from the first reflection surface 4b of the mirror 4a and is scanned over a prescribed range is a duration for detecting the object (the object 50a in FIG. 7) that is located at a remote distance.

For this reason, during the first scanning duration (hereinafter referred to as “one first scanning duration”) during the laser light from the LD group 2a is reflected from one first reflection surface 4b and is scanned over the prescribed range, the control unit 1, as illustrated in FIG. 9, causes a plurality of laser diodes, the LD₁ to the LD₈, to be sequentially emitted. For details, the one-time emitting of the LD₁ to the LD₈ in this order is repeatedly performed. In FIG. 9, the sequential emitting of the LD₁ to the LD₈ is performed one time, but the number of times of repetition may be suitably set. Accordingly, the laser light from each of the LD₁ to LD₈ is projected and the laser light is scanned by the rotary scanning unit 4 over the prescribed range in the horizontal direction and the perpendicular direction. After the light emission by each LD, the control unit 1 charges the capacitor 2c (FIG. 5) that releases electric charge and thus is discharged.

Furthermore, during one first scanning duration, the control unit 1 causes the PD₁ to PD₁₆, which correspond to the LD₁ to LD₈ in a light-emitted state among a plurality of photodiodes, the PD₁ to the PD₁₆, to sequentially receive the reflection light, and causes the MUX 7c to select the light reception signals that are output from the PD₁ to PD₁₆ in the light-received state. Specifically, first, when the LD₁ is caused to emit light, the PD₁ and the PD₂, which correspond to the LD₁, are caused to receive the reflection light, the MUX 7c is caused to select the light reception signal from the PD₁, and the selected light reception signal is caused to be output to the comparator 8a via the high-speed amplifier 7d. Furthermore, the MUX 7c is caused to select the light reception signal from the PD₂, and the selected light reception signal is caused to be output to the comparator 8b via the high-speed amplifier 7e.

Next, when the LD₂ is caused to emit light, the PD₃ and the PD₄, which correspond to the LD₂, are caused to receive the reflection light, the MUX 7c is caused to select the light reception light from the PD₃, and the selected light reception signal is caused to be output to the comparator 8a via the high-speed amplifier 7d. Furthermore, the MUX 7c is caused to select the light reception signal from the PD₄, and the selected light reception signal is caused to be output to the comparator 8b via the high-speed amplifier 7e. Next, when the LD₃ is caused to emit light, the PD₅ and the PD₆, which correspond to the LD₃, are caused to receive the reflection light, the MUX 7c is caused to select the light reception signal from the PD₅, and the selected light reception signal is caused to be output to the comparator 8a via the high-speed amplifier 7d. Furthermore, the MUX 7c is caused to select the light reception signal from the PD₆, and the selected light reception signal is caused to be output to the comparator 8b via the high-speed amplifier 7e. Next, when the LD₄ is caused to emit light, the PD₇ and the PD₈, which correspond to the LD₄, are caused to receive the reflection light, the MUX 7c is caused to select the light reception signal from the PD₇, and the selected light reception signal is caused to be output to the comparator 8a via the high-speed amplifier 7d. Furthermore, the MUX 7c is caused to select the light reception signal from the PD₈, and the selected light reception signal is caused to be output to the comparator 8b via the high-speed amplifier 7e.

In the same manner, the LD₅ to the LD₈ are caused to sequentially emit light, two PDs that correspond to each LD are caused to sequentially receive the reflection light, the MUX 7c is caused to sequentially select the light reception signal from the PD and the selected light reception signal is output to the comparator 8a or 8b via the high-speed amplifier 7d or 7e, respectively, according to the PD. Thereafter, the LD, the PD, and the MUX 7c, and the high-speed amplifiers 7d and 7e are over again caused to operate in the order described above.

Furthermore, in one first scanning duration, the control unit 1 drives the comparators 8a and 8b and the ADCs 9a and 9b, and processes the light reception signal that is output at any time from the light receiving module 7. At this time, the light reception signals from the PD₁, the PD₃, the PD₅, the PD₇, the PD₉, the PD₁₁, the PD₁₃, and the PD₁₅ are processed in the comparators 8a and the ADC 9a, and the light reception signals from the PD₂, the PD₄, the PD₆, the PD₈, the PD₁₀, the PD₁₂, the PD₁₄, and the PD₁₆ are processed in the comparators 8b and the ADC 9b. The ADCs 9a and 9b intermittently operate so as to correspond to switching of selection of the light reception signals by the MUX 7c (this is also the same as during the second scanning duration that will be described below).

Then, during one first scanning duration, based on the light reception signal that is output at any time from the ADC 9a or the ADC 9b, the object detection unit 1a determines whether the object 50 is present or absent and measures the distance to the object 50. The object detection unit 1a calculates the distance to the object 50 using the TOF method. Furthermore, based on the PD that is an output source of the light reception signal which is detected that the object 50 is present, a direction in which the object 50 is present may also be measured.

During one other first scanning duration in which the laser light from the LD group 2a is reflected from one other first reflection 4b and is scanned over a prescribed range, in the same manner as during the one first scanning duration described above, the LD, the PD, the MUX 7c, the high-speed amplifiers 7d and 7e, the comparators 8a and 8b, the ADCs 9a and 9b, and the object detection unit 1a are also caused to operate as illustrated in FIG. 9.

In contrast, the second duration in which, with the rotary scanning unit 4, the laser light from the LD group 2a is reflected from the second reflection surface 4c of the mirror 4a and is scanned over a prescribed range is a duration for detecting the objects (the object 50b and 50c in FIG. 8) that is located at a short distance.

For this reason, during the second scanning duration (hereinafter referred to as one second scanning duration) during which the laser light from the LD group 2a is reflected from the second reflection surface 4c and is scanned over a prescribed range, the control unit 1, as illustrated in FIG. 10, causes a specific LD₄ among a plurality of laser diodes, the LD₁ to the LD₈, to emit light multiple times with a prescribed period. In FIG. 10, the LD₄ is caused to emit light 16 times, but the number of times of light emission may be suitably set. Accordingly, the laser light from the LD₄ is projected horizontally and the laser light is scanned by the rotary scanning unit 4 over the prescribed range in the horizontal direction. After the light emission by the LD₄, during the time that the LD₄ takes to emit light again, the control unit 1 charges the capacitor 2c (FIG. 5) that releases electric charge and thus is discharged.

Furthermore, during one second scanning duration, each time the LD₄ is caused to emit light, the control unit 1 sets a plurality of photodiodes, the PD₁ to PD₁₆, sequentially in pairs to be in a light-received state, and causes the MUX 7c to select the light reception signals that are output from the PD₁ to the PD₁₆ in the light-received state. For details, two PDs in a pair, which correspond to each LD, are caused each time to sequentially receive the reflection light each time, and the MUX 7c is caused to select the light reception signals that are output from the two PDs in the light-received state. Thereafter, in the same manner, two PDs in a pair are caused to sequentially receive the reflection light each time, and the MUX 7c is caused to select the reception signals that are output from the two PDs in the light-received state.

Specifically, first, for the first light emission by the LD₄, the PD₁ and the PD₂, are caused to receive the reflection light, the MUX 7c is caused to select the light reception signal from the PD₁, and the selected light reception signal is output to the comparator 8a via the high-speed amplifier 7d. Furthermore, the MUX 7c is caused to select the light reception signal from the PD₂, and the selected light reception signal is caused to be output to the comparator 8b via the high-speed amplifier 7e. Next, for the second light emission by the LD₄, the PD₃ and the PD₄ are caused to receive the reflection light, the MUX 7c is caused to select the light reception signal from the PD₃, and the selected light reception signal is caused to be output to the comparator 8a via the high-speed amplifier 7d. Furthermore, the MUX 7c is caused to select the light reception signal from the PD₄, and the selected light reception signal is caused to be output to the comparator 8b via the high-speed amplifier 7e. Next, for the third light emission by the LD₄, the PD₅ and the PD₆ are caused to receive the reflection light, the MUX 7c is caused to select the light reception signal from the PD₅, and the selected light reception signal is output to the comparator 8a via the high-speed amplifier 7d. Furthermore, the MUX 7c is caused to select the light reception signal from the PD₆, and the selected light reception signal is caused to be output to the comparator 8b via the high-speed amplifier 7e. Next, for the fourth light emission by the LD₄, the PD₇ and the PD₈ are caused to receive the reflection light, the MUX 7c is caused to select the light reception signal from the PD₇, and the selected light reception signal is caused to be output to the comparator 8a via the high-speed amplifier 7d. Furthermore, the MUX 7c is caused to select the light reception signal from the PD₈, and the selected light reception signal is caused to be output to the comparator 8b via the high-speed amplifier 7e.

In the same manner, for the fifth light emission to the eighth light emission by the LD₄, two PDs are caused to sequentially emit the reflection light, and the MUX 7c is caused to sequentially select the light reception signal from each PD, and the selected light reception signal is output to the comparator 8a or 8b via the high-speed amplifier 7d or 7e, respectively, according to the PD. Thereafter, for the ninth light emission and subsequent light emission by the LD₄, the LD, the PD, and the MUX 7c, and the high-speed amplifiers 7d and 7e are over again caused to operate in the order described above.

Furthermore, in one second scanning duration, the control unit 1 drives the comparators 8a and 8b and the ADCs 9a and 9b, and processes the light reception signal that is output at any time from the light receiving module 7. Then, based on the light reception signal that is output at any time from the ADC 9a or the ADC 9b, the object detection unit 1a determines whether the object 50 is present or absent or measures the distance to the object 50. The distance to the object 50 may be calculated by the object detection unit 1a using the TOF method, and, as described above with reference to FIG. 8, may be calculated based on the arrival angle of the reflection light due to the object 50 and on a prescribed arithmetic-operation expression. Furthermore, because the object 50 that is detected during the second scanning duration is located at a short distance, the measurement of the distance to the object 50 may be omitted.

During one other second scanning duration during which the laser light from the LD group 2a is reflected from one other second reflection 4c and is scanned over a prescribed range, in the same manner as during the one second scanning duration described above, the LD, the PD, the MUX 7c, the high-speed amplifiers 7d and 7e, the comparators 8a and 8b, the ADCs 9a and 9b, and the object detection unit 1a are also caused to operate as illustrated in FIG. 10.

According to the embodiment described above, during the first scanning duration, the laser light from each of the plurality of LDs is projected sequentially, and the laser light is reflected from the first reflection surface 4b of the mirror 4a of the rotary scanning unit 4 and is scanned over a prescribed range. At this time, in a case where the object 50 is located at a remote distance, the laser light from any of the LDs is reflected from the object 50, the reflection light is incident on the PD that corresponds to the LD. For this reason, the MUX 7c is caused to select the light reception signal that is output from the PD which corresponds to the LD in the light-emitted state, and thus the object 50 can be detected precisely by the object detection unit 1a based on the light reception signal.

Furthermore, during the second scanning duration, the laser light is projected with a prescribed period from a specific LD₄, and the laser light is reflected from the second reflection surface 4c of the mirror 4a of the rotary scanning unit 4 and is scanned over a prescribed range. At this time, if the object 50 is located at a short distance, in some cases, the reflection light that results from the laser light being reflected from the object 50 is incident on the PD (PD other than the PD₇ and PD₈) that does not correspond to a specific LD₄. However, a plurality of PDs are caused to sequentially receive the reflection light and the MUX 7c is caused to sequentially select the light reception signal that is output from the PD in the light-received state. Because of this, the reflection light is received in any of the PDs and the MUX 7c is caused to select the light reception signal that is output from the PD. More precisely, switching among a plurality of PDs and between the light reception signals that are output from the plurality of PDs are performed and thus the reflection light that results from the laser light from a specific LD₄ being reflected from the object 50 is searched for. For this reason, any of the PDs is caused to receive the reflection light, the MUX 7c is caused to select the light reception signal that is output from the PD, and thus, based on the light reception signal, the object 50 can be detected precisely by the object detection unit 1a.

Furthermore, in the embodiment described above, the width W2 of the second reflection surface 4c in parallel with the scanning plane for the laser light from the LD, which results from the rotary scanning unit 4 is narrower than the width W1 of the first reflection surface 4b in parallel with the scanning plane. For this reason, during the second scanning duration, the time for which the laser light projected from a specific LD₄ is scanned over a prescribed range and the time for which the switching among a plurality of PDs and the light reception signals that are output from the plurality of PDs are performed can be shortened. Then, the LD, the PD, the MUX 7c, the comparators 8a and 8b, and the ADCs 9a and 9b, or the object detection unit 1a is caused to pause for a time that is as long as the shortened time. Thus, the load on these operations or these types of processing can be reduced.

Furthermore, in the embodiment described above, the mirror 4a of the rotary scanning unit 4 is formed in the shape of a plate, the first reflection surface 4b is provided on both entire plate-shaped surfaces of the mirror 4a, and the second reflection surface 4c is provided on both side surfaces, an area of each of which is smaller than that of the mirror 4a. For this reason, an area of the second reflection surface 4c is set to be smaller than an area of the first reflection surface 4b, and thus, the second scanning duration can be further shortened than the first scanning duration. Then, the LD, the PD, the MUX 7c, the comparators 8a and 8b, and the ADCs 9a and 9b, and the object detection unit 1a are caused to pause. Thus, the load on these operations or these types of processing can be further reduced.

Furthermore, in the embodiment described above, a plurality of LDs are arranged so as to be aligned in a direction (upward and downward) perpendicular to the scanning plane for the laser light resulting from the rotary scanning unit 4. For this reason, the laser light can be scanned not only in the horizontal direction, but also in the vertical direction, and it is possible that the precision of the detection of the object 50 is further improved.

Furthermore, in the embodiment described above, during the first scanning duration, the PD that corresponds to the LD in the light-emitted state or also to the reflection direction of the laser light from the LD, which results from the first reflection surface 4b, is caused to sequentially receive the reflection light from the object 50. For this reason, in a case where the object 50 is located at a remote distance, the MUX 7c is caused to select the light reception signal that is output from the PD in the light-received state, and thus, based on the light reception signal, the object 50 can be detected more precisely by the object detection unit 1a.

Furthermore, in the embodiment described above, during the first scanning duration, the object 50 that is detected is regarded as being located at a remote distance based on the light reception signal that is output from the light receiving module 7, and the distance to the object 50 is measured by the object detection unit 1a. Thus, a movement of the object 50 can be tracked. Furthermore, during the second scanning duration, the object 50 is regarded as being located at a short distance base on the light reception signal that is output from the light receiving module 7, and it is determined whether the object 50 is present or absent. Thus, the load on the object detection unit 1a can be reduced.

Moreover, in the embodiment described above, the ADCs 9a and 9b intermittently operate so as to correspond to switching of selection of the light reception signals by the MUX 7c. For this reason, the time for which the ADCs 9a and 9b are caused to pause is lengthened, and thus the load on the processing by each of the ADC 9a and 9b can be more reduced than in a case where the ADCs 9a and 9b always operates. Then, heat that is generated from the ADCs 9a and 9b is reduced, and thus it is possible that an element (a CPU or the like that constitutes the control unit 1) that is positioned in the ADCs 9a and 9b or in the vicinity of each of the ADCs 9a and 9b is prevented from malfunctioning.

In addition to the embodiment described above, various embodiments of the present invention can be employed. For example, in the embodiment described above, an example is described in which the LD is used as a light emitting element and the PD is used as a light receiving element. However, the present invention is not limited only to these. A suitable number of light emitting elements other than the LD may be provided on the light emitting module 2. Furthermore, a suitable number of light receiving elements other than a PIN-type PD such as an avalanche photodiode (APD) may be provided in the light receiving module 7. Furthermore, one or more single photon avalanche diodes (SPAD)s that are Geiger mode APDs, one or more multi-pixel photon counters (MPPC) each of which results from connecting a plurality of SPADs in parallel, or the like may be provided as light receiving elements in the light receiving module 7. Moreover, an arrangement of a plurality of light emitting elements or of a plurality of light receiving elements may be suitably set.

Furthermore, in the embodiment described above, an example is described in which a pair of PDs corresponds to each of the plurality of LDs, but the present invention is not limited only to this. In addition to this, for example, one PD or three or more PDs may correspond to each of the plurality of LDs. Furthermore, the numbers of PDs that correspond to each LD may be the same or may be different. Furthermore, during the first scanning duration, the order in which a plurality of LDs emit light, the order in which a plurality of PDs receive light, or the order in which the light reception signals are selected may be suitably set. Moreover, during the second scanning duration, the LD that is caused to emit light, the order in which a plurality of PDs receive light, or the order in which the light reception signals are selected may be suitably set.

Furthermore, in the embodiment described above, an example is described in which the first reflection surface 4b is provided on both plate-shaped large-in-area surfaces of the mirror 4a in the shape of a plate, of the rotary scanning unit 4, and in which the second reflection surface 4c is provided on both small-in-area side surfaces, but the present invention is not limited only to this. In addition to this, for example, one of the both plate-shaped surfaces of the mirror 4a in the shape of a plate may be provided on the first reflection surface, and the other may be provided on the second reflection surface. Furthermore, a rotary scanning unit that has a mirror, such as a polygon mirror, of which three or more side surfaces are reflection surfaces, or a rotary scanning unit that has a mirror in other shapes, to which a plurality of reflection surfaces are provided may be used. Then, one of the plurality of reflection surfaces of the mirror may be set to be the first reflection surface, and the other may be set to be the second reflection surface. Furthermore, the number of first reflection surfaces and the number of second reflection surfaces may be 1 or may be 2 or greater. An area of the first reflection surface and an area of the second reflection surface may be different or may be the same. Moreover, for example, the laser light from the LD is scanned over the prescribed range by the rotary scanning unit, but a shape of the rotary scanning unit may be designed or the rotary scanning unit or the light receiving element may be positioned in such a manner that the reflection light that results from the object which is present in the prescribed range is received in the light receiving element without being caused to go by way of the rotary scanning unit.

Furthermore, according to the present embodiment, an example is described in which, as the signal selection unit that selects the light reception signal which is output from each of the plurality of PDs, the MUX 7c is provided in the light receiving module 7, but the present invention is not limited only to this. A signal selection unit other than the MUX may be the light receiving module 7. Furthermore, the signal selection unit may be provided outside of the light receiving module 7.

Furthermore, in the embodiment described above, an example is described in which the voltage signal from the light receiving module 7 is output as the light reception signal and is processed downstream, but the present invention is not limited only to this. In addition to this, for example, a current signal in accordance with output current from each light receiving element is output as the light reception signal from the light receiving module and is processed in the comparator, the ADC, or the control unit on the downstream side. Thus, it may be determined whether the object is present or absent or the distance to the object may be measured.

Moreover, the embodiment described above shows an example applied to the object detection apparatus 100 that is made up of the laser radar for the vehicle, but object detection apparatuses for other purposes may be applied to one or more embodiments of the present invention.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. An object detection apparatus comprising:
a plurality of light emitting elements;
a rotary scanning unit that comprises a mirror, and by causing the mirror to rotate, reflects projection light projected from the light emitting elements by the mirror and scans the reflected projection light over a prescribed range;
a plurality of light receiving elements each of which receives reflection light of the projection light and reflected from an object in the prescribed range and which outputs a light reception signal in accordance with a light-received state;
a signal selection unit that selects any of light reception signals output from the plurality of light receiving elements; and
an object detection unit that detects the object based on the light reception signal which is selected by the signal selection unit,
wherein the mirror comprises a first reflection surface and a second reflection surface that do not belong in a same plane,
wherein during a first scanning duration in which the projection light is reflected by the rotary scanning unit from the first reflection surface and is scanned over the prescribed range, the plurality of light emitting elements are caused to sequentially emit light, the light receiving element that corresponds to a light emitting element in a light-emitted state of the plurality of light receiving elements is caused to sequentially receive the reflection light, and the signal selection unit is caused to sequentially select the light reception signal that is output from the light receiving element in the light-received state, and
wherein during a second scanning duration in which the projection light is reflected by the rotary scanning unit from the second reflection surface and is scanned over a prescribed range, a specific light emitting element of the plurality of light emitting elements is caused to emit light with a prescribed period, the plurality of light receiving elements are caused to sequentially receive the reflection light, and the signal selection unit is caused to sequentially select the light reception signal that is output from the light receiving element in the light-received state.

2. The object detection apparatus according to claim 1,
wherein a width of the second reflection surface in parallel with a scanning plane for the projection light resulting from the rotary scanning unit is narrower than a width of the first reflection surface in parallel with the scanning plane.

3. The object detection apparatus according to claim 1,
wherein the mirror is formed in a plate shape,
wherein the first reflection surface is provided on a plate-shaped surface of the mirror, and
wherein the second reflection surface is provided on a side surface of the mirror which has an area smaller than that of the plate-shaped surface.

4. The object detection apparatus according to claim 1,
wherein the plurality of light emitting elements are arranged so as to be aligned in a direction perpendicular to the scanning plane for the projection light resulting from the rotary scanning unit, and
wherein during the first scanning duration, the light receiving element corresponding to the light emitting element in the light-emitted state and also corresponding to a reflection direction of the projection light resulting from the first reflection surface is caused to sequentially receive the reflection light.

5. The object detection apparatus according to claim 1,
wherein during the first scanning duration, the object detection unit measures a distance to the object based on the light-emitted state of the light emitting element and based on the light reception signal that is selected by the signal selection unit, and
wherein during the second scanning duration, the object detection unit determines whether the object is present or absent, based on the light-emitted state of the light emitting element and based on the light reception signal that is selected by the signal selection unit.

6. The object detection apparatus according to claim 1, further comprising:
an analog-to-digital converter that converts the light reception signal in analog form, which is selected by the signal selection unit, into a light reception signal in digital form, and outputs the light reception signal to the object detection unit,
wherein the analog-to-digital converter is caused to intermittently operate so as to correspond to switching of selection of the reception light signals by the signal selection unit.
